(19) United States
(12) Patent Application Publication
(10) Pub. No.: US 2026/0343060 A1
(43) Pub. Date: Oct. 29, 2026

(54) METHOD, DEVICE, AND STORAGE MEDIUM FOR SEARCH

(71) Applicant: Bytedance Technology Ltd., Grand Cayman (KY)

(72) Inventors: Xiaotong MA, Beijing (CN); Daoyu WANG, Beijing (CN)

(21) Appl. No.: 19/418,462

(22) Filed: Dec. 12, 2025

(30) Foreign Application Priority Data
Apr. 23, 2025 (CN) 202510523591.9

(51) Int. Cl. H04N 21/4725; H04N 21/431; H04N 21/462; H04N 21/472; H04N 21/478

(52) U.S. Cl. CPC H04N 21/4725; H04N 21/4316; H04N 21/4622; H04N 21/47217; H04N 21/47815

(57) ABSTRACT

The present disclosure provides a method, an apparatus, a device, a storage medium and a program product for search. The method includes: presenting media content in a first interface; and presenting a first panel in the first interface in response to a trigger on the media content, the first panel including: at least one interactive control configured to trigger a corresponding interactive operation on the media content, and a plurality of search items matching at least one object identified from the media content.

### CROSS-REFERENCE

The present application claims priority to Chinse Patent Application No. 202510523591.9, filed on Apr. 23, 2025, entitled “METHOD, APPARATUS, DEVICE, STORAGE MEDIUM AND PROGRAM PRODUCT FOR SEARCH”, the disclosures of which are incorporated herein by reference in their entireties.

### FIELD

Example embodiments of the present disclosure generally relate to the field of computers, and in particular, to a method, an apparatus, an electronic device, a computer-readable storage medium and a computer program product for search.

### BACKGROUND

With the rapid development of the Internet, more and more applications are designed to provide various services to users. For example, an application may provide a search service to a user. An application may provide an interface for presenting media content to a user, and the media content may include any appropriate type of content such as images, text, video, audio, and the like. If the content of the media content is associated with an object, it is expected to improve the efficiency of the user in obtaining other information matching the object.

### SUMMARY

In a first aspect of the present disclosure, a method for search is provided. The method includes: presenting media content in a first interface; and presenting a first panel in the first interface in response to a trigger on the media content, the first panel including: at least one interactive control configured to trigger a corresponding interactive operation on the media content, and a plurality of search items matching at least one object identified from the media content.

In a second aspect of the present disclosure, an apparatus for search is provided. The apparatus includes: a media content presenting module configured to present media content in a first interface; and a panel presenting module configured to present a first panel in the first interface in response to a trigger on the media content, the first panel including: at least one interactive control configured to trigger a corresponding interactive operation on the media content, and a plurality of search items matching at least one object identified from the media content.

In a third aspect of the present disclosure, an electronic device is provided. The device includes at least one processor; and at least one memory coupled to the at least one processor and storing instructions executable by the at least one processor. The instructions, when executed by the at least one processor, cause the electronic device to perform the method of the first aspect.

In a fourth aspect of the present disclosure, a computer-readable storage medium is provided. The computer-readable storage medium has computer-executable instructions stored thereon which, when executed by a processor, implement the method of the first aspect.

In a fifth aspect of the present disclosure, a computer program product is provided. The computer program product includes computer-executable instructions which, when executed by a processor, implement the method according to the first aspect of the present disclosure.

It should be understood that the content described in the content section of the present disclosure is not intended to identify the key features or important features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure may be implemented;

FIGS. 2A-2I show example interfaces for search according to some embodiments of the present disclosure;

FIG. 3 shows a flowchart of a method for search according to some embodiments of the present disclosure;

FIG. 4 shows an example structural block diagram of an apparatus for search according to some embodiments of the present disclosure; and

FIG. 5 shows a block diagram of an electronic device in which one or more embodiments of the present disclosure can be implemented.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the drawings and embodiments of the present disclosure are only for example purposes, and are not intended to limit the protection scope of the present disclosure.

In the description of the embodiments of the present disclosure, the term "include/comprise" and similar terms should be understood as open-ended inclusion, that is, "include/comprise but not limited to". The term "based on" should be understood as "at least partially based on". The term "one embodiment" or "the embodiment" should be understood as "at least one embodiment". The term "some embodiments" should be understood as "at least some embodiments". The following may also include other explicit and implicit definitions.

Herein, unless explicitly stated, "performing a step in response to A" does not mean performing the step immediately after "A", but may include one or more intermediate steps.

It should be understood that the data involved in the technical solution (including but not limited to the data itself, data acquisition or use) should comply with the requirements of corresponding laws, regulations and related provisions.

It should be understood that before using the technical solution disclosed in the embodiments of the present disclosure, the user should be informed of the type, range of use, use scenarios, etc. of personal information involved in the present disclosure in an appropriate manner in accordance with relevant laws and regulations, and the authorization of the user should be obtained.

For example, in response to receiving an active request from a user, prompt information is sent to the user to clearly prompt the user that the requested operation will require access to and use of the user’s personal information, so that the user may independently choose whether to provide the personal information to software or hardware, such as an electronic device, an application, a server or a storage medium, that performs the operations of the technical solution of the present disclosure based on the prompt information.

As an optional but non-limiting implementation, in response to receiving an active request from a user, a way to send prompt information to the user may be, for example, a pop-up window, in which the prompt information may be presented in text. In addition, the pop-up window may also include a selection control for the user to select "agree" or "disagree" to provide personal information to the electronic device.

It should be understood that the above process of notifying and obtaining user authorization is only illustrative, and does not limit the implementations of the present disclosure. Other ways that meet relevant laws and regulations may also be applied to the implementations of the present disclosure.

In the present disclosure, "trigger" refers to one or more interactive operations of a user on a terminal device. Further, these interactive operations may be triggered within a same user interface/popup window, or may be triggered within different user interfaces/popup windows. The present disclosure is not limited in this regard.

In the present disclosure, "object" may refer to any physical or virtual object, including but not limited to, physical or virtual products, media works, etc.

As briefly mentioned above, an application may provide a user with an interface for presenting media content, and the media content may include any appropriate type of content such as images, text, video, audio, and the like. The media content may also include any appropriate content. The content of the media content may be associated with an object. For example, the media content may include a display of products such as clothing and accessories. Traditionally, if a user expects to search for an object in the media content, the user may try to perform a text search for a name of the object appearing in the media content in a search box, or perform an image search through a screenshot, etc., to find other relevant content. This way requires the user to perform various steps of interactions, which will affect the efficiency of the user in searching for the object.

In view of this, the present disclosure proposes an improved solution for search. According to the solution of the embodiments of the present disclosure, media content is presented in a first interface. A first panel is presented in the first interface in response to a trigger on the media content. The first panel includes at least one interactive control and a plurality of search items matching at least one object identified from the media content, where each interactive control is configured to trigger a corresponding interactive operation on the media content.

In this way, in the case where the media content is triggered, in addition to providing an interactive control, a plurality of search items matching the object in the media content are further provided in the presented panel. The user may obtain various search results corresponding to the object in the media content conveniently and quickly by simply triggering the presented panel, without the need for the user to perform complex interactions, which may improve the efficiency of the user in obtaining information.

FIG. 1 shows a schematic diagram of an example environment 100 in which the embodiments of the present disclosure may be implemented. In the example environment 100, an instance of an application 120 is installed on a terminal device 110. A user 140 may interact with the application 120 via an attachment device of the terminal device 110. Similarly, the user 140 may interact with the application 120 via the terminal device 110 and/or an attachment device of the terminal device 110.

In some embodiments, the application 120 may be any appropriate application that may provide a service associated with media content for the user 140. The media content may also be referred to as a media content item, a content item, etc. The service associated with the media content may include browsing, commenting, forwarding, creation (for example, shooting and/or editing), publishing, etc., of the media content. The media content may include one or more types of content, such as video, images, animated images, image collections, graphic and text works, audio, text, and the like.

In the environment 100 of FIG. 1, if the application 120 is in an active state, the terminal device 110 may present an interface 150 of the application 120. The interface 150 may include various interfaces that may be provided by the application 120, such as a content presenting interface, a search interface, a query interface, a search result presenting interface, and the like.

In some embodiments, the terminal device 110 communicates with a server 130 to implement the provision of the service of the application 120. The terminal device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the terminal device 110 may also support any type of user-specific interface (such as "wearable" circuitry, etc.).

The server 130 may be an independent physical server, a server cluster or a distributed system composed of a plurality of physical servers, or may provide cloud services, cloud databases, cloud computing, cloud functions, cloud storage, network services, cloud communications, middleware services, domain name services, security services, content delivery networks, and basic cloud computing services such as big data and artificial intelligence platforms. The server 130 may include, for example, a computing system/server, such as a mainframe, an edge computing node, a computing device in a cloud environment, and the like.

It should be understood that the structure and function of each element in the environment 100 are described only for the purpose of illustration, without implying any limitation on the scope of the present disclosure.

Some example embodiments of the present disclosure will be described below with continued reference to the drawings. The search method involved in the present disclosure may be implemented on the terminal device 110. It should be noted that the operations performed by the terminal device 110 may be specifically performed by a related application (for example, the application 120) installed on the terminal device 110. Some operations described with reference to the terminal device 110 may require the assistance of the server 130 to complete.

It should be understood that the interfaces shown in the drawings are only examples, and various interface designs may actually exist. The respective graphic elements in the interface may have different arrangements and different visual representations, one or more of the elements may be omitted or replaced, and there may also be one or more other elements. The embodiments of the present disclosure are not limited in this regard.

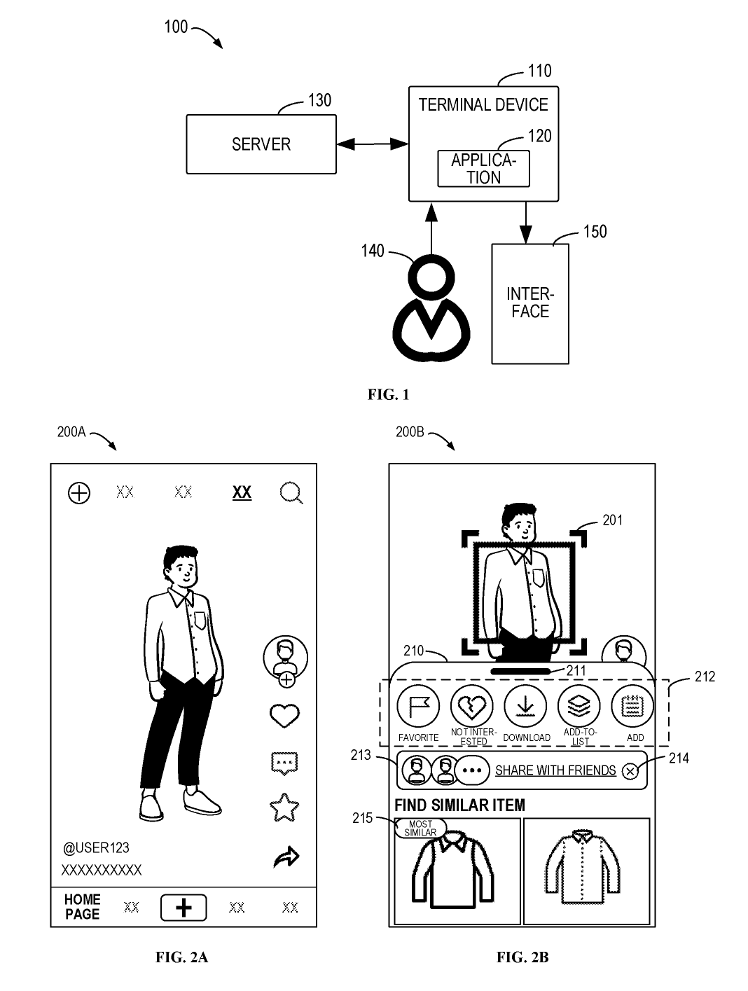

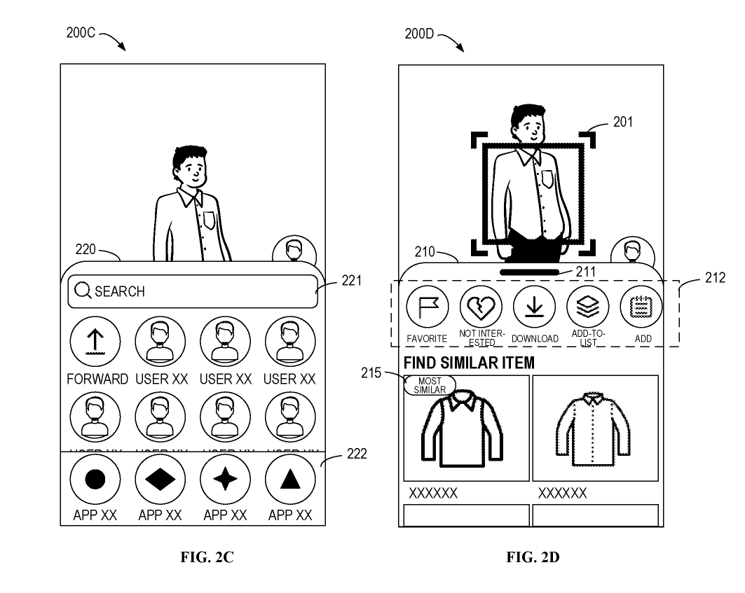

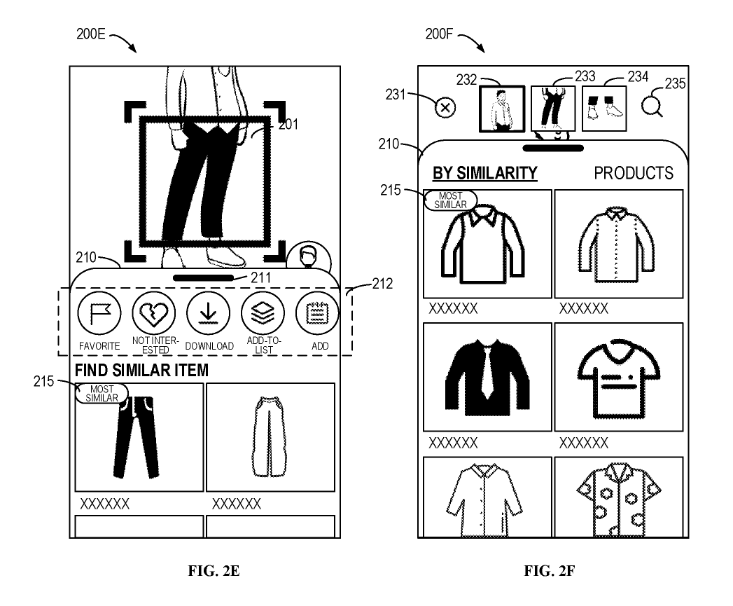

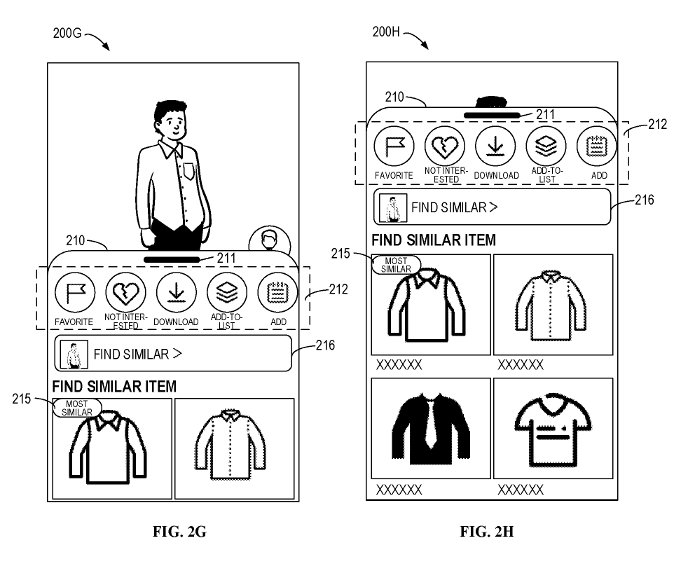

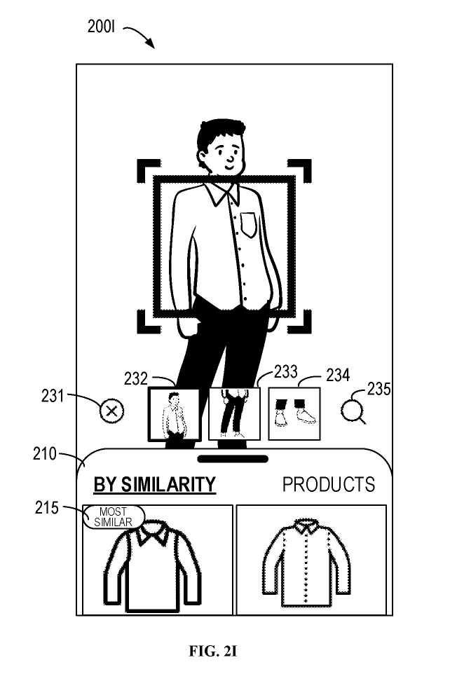

FIGS. 2A-2I show example interfaces 200A to 200I for search according to some embodiments of the present disclosure. The interfaces shown in the example interfaces 200A to 200I may be presented at the terminal device 110. For the convenience of discussion, the example interfaces 200A to 200I will be described with reference to the environment 100 of FIG. 1. The terminal device 110 may be used for interaction by receiving an operation of an associated user (for example, the user 140) to present a corresponding interaction result.

In the environment 100, the terminal device 110 presents an interface 150 of the application 120. The interface 150 may be, for example, a content presenting interface of the application 120 (which for example may also be referred to as a first interface, a presenting interface, etc.), and the terminal device 110 may present media content in the content presenting interface. The media content may include at least visual content, such as images, videos, graphic and text works. In some embodiments, the content presenting interface may be an interface for displaying or pushing media content and other related information to the user. A set of media content presented in the content presenting interface may include various types of media content. The media content item to be presented in a specific content presenting interface may be determined according to the application design needs. The specific media content to be presented and the number thereof will vary in different scenarios.

In some embodiments, the content presenting interface may include a home page of the application 120, or a recommended home page in a set of home page interfaces of the application 120. The recommended data presented to the user in the recommended home page is sometimes also referred to as a recommended information flow. In some embodiments, the content presenting interface may further include a specific content presenting interface of the application 120, which for example may be used to present a media content item posted by a specific user. That is, the media content item presented by the terminal device 110 in the first interface may be a media content item in the information flow or the recommended flow of the application 120, or may be a media content item posted by a specific user.

The terminal device 110 may present a first panel in the first interface in response to a trigger on the media content. For example, the terminal device 110 may determine that the trigger on the media content is received in response to receiving a long press operation, a selection operation, etc., on the media content. In the embodiments of the present disclosure, generally, if a user trigger is detected during the presentation of the media content (for example, during the playing of a video), it means that the user expects to perform a certain interaction on the media content. Therefore, the presented first panel includes at least one interactive control. An interactive control is configured to trigger a corresponding interactive operation on the media content. The at least one interactive control may include any appropriate control such as a favorite control, a download control, a sharing control, an add-to-viewing-list control, and the like.

On the other hand, in addition to performing interactive operations on the media content itself, when triggering the media content, the user may also expect to view more information about a certain object appearing in the media content. Therefore, in the embodiments of the present disclosure, the presented first panel further includes a plurality of search items matching at least one object identified from the media content. A search item here may include media content (for example, video, image, graphic and text works, etc.) of the same or similar object, and may include non-media content (such as product items, etc.) of the same or similar object. For example, if the at least one object includes an object A, the search items may be media content including objects similar to the object A, or may be products similar to the object A. The terminal device 110 may present the plurality of search items in the first panel in any appropriate form. As an example, the terminal device 110 may present a plurality of search item cards in the first panel, each search item card presenting one search item.

In some embodiments, for each object identified from the media content, the terminal device 110 may determine attribute information of the object. The attribute information of the object may indicate a category of the object, which may include a product, an encyclopedia entity, media content, and the like. The terminal device 110 may further determine a type of a search item matching the object based on the attribute information of the object. The type of the search item may include a product type, an encyclopedia type, a media work type (or may be further subdivided into a video work type, a graphic and text work type, etc.), and the like. For example, if the attribute information of a certain object indicates that the category of the object is a product, it may be determined that the type of the search item matching the object is the product type, and a plurality of search items (for example, a plurality of product cards) matching the object under the product type are obtained and presented accordingly. If the attribute information of a certain object indicates that the category of the object is an encyclopedia, it may be determined that the type of the search item matching the object is the encyclopedia type, and a plurality of pieces of encyclopedia content are obtained and presented accordingly; and so on. Certainly, if a certain object may match the types of a plurality of search items, the search items of the plurality of types may also be presented. These search items may be presented in a mixed manner, or may be divided by classification labels, so that the user may select the presentation according to actual needs.

As an example, referring to FIGS. 2A and 2B, the terminal device 110 may present the first interface shown in the example interface 200A, and the example interface 200A presents the media content. The terminal device 110 may present the example interface 200B in response to receiving the trigger on the media content in the example interface 200A. The example interface 200B includes a first panel 210. The first panel 210 may include at least one interactive control and a plurality of search items matching at least one object identified from the media content.

In some embodiments, the terminal device 110 may further sort the plurality of search items based on the similarities between the plurality of search items and the object in the media content, and present the plurality of search items in the first panel based on the sorting result. For example, the higher the similarity of the search item, the higher the order of the presentation. In this case, the terminal device 110 may present a label 215 at the first search item (that is, the search item corresponding to the highest similarity) among the plurality of search items, and the label 215 may indicate that the similarity between the first search item and the object in the media content is the highest.

In some embodiments, the first panel 210 may include an area 212, which includes at least a part of the at least one interactive control (for example, other controls than the sharing control), such as a favorite control, a not interested control, a download control, an add-to-list control, an add-mark control, etc., as shown in the figure. In some embodiments, since the size of the first interface is limited, if there are a relatively large number of interactive controls (which may be referred to as a first group of interactive controls, for example) to be presented in the area 212, the terminal device 110 may only present some of the interactive controls in the area 212. In this case, the terminal device 110 may present other interactive controls, for example, in response to receiving a swipe operation on the area 212.

In some embodiments, the first panel 210 includes at least a sharing control 213. With reference to FIG. 2C, the terminal device 110 may present a sharing panel 220 (for example, which may also be referred to as a second panel) in response to receiving a trigger on the sharing control 213 in the example interface 200B. The sharing panel 220 includes at least one sharing target associated with the media content.

The at least one sharing target may include at least one user associated with the user 140 in the application 120. The at least one user associated with the user 140 may include any appropriate user such as a friend of the user 140, a user subscribed by the user 140 historically, a user interacted with the user 140 historically (for example, if the user 140 has a chat with a user A historically, the user A is a user interacted with the user 140 historically), and the like. The at least one sharing target may further include a third-party platform/application. For example, the third-party platform/application may include a platform/application currently installed on the terminal device 110. Referring to FIG. 2C, the sharing panel 220 may include, for example, an area 222, and the area 222 may present at least one third-party platform/application.

In some embodiments, the sharing panel 220 may further include a search box 221. The terminal device 110 may, in response to receiving a user input via the search box 221, search for a sharing target matching the user input from the at least one sharing target to which the user 140 may share the media content based on the user input. This may help improve the efficiency of finding a sharing target.

Referring to FIGS. 2B and 2D, in some embodiments, the terminal device 110 may further present a cancel control 214 in association with the sharing control 213. The terminal device 110 may cancel presenting the sharing control in the first panel 210 in response to receiving a trigger on the cancel control 214. For example, the terminal device 110 may present the example interface 200D in response to receiving the trigger on the cancel control 214 in the example interface 200B, and the first panel 210 in the example interface 200D does not include the sharing control 213.

In some embodiments, the plurality of search items presented in the first panel are associated with a clip of the media content that is triggered. For example, the terminal device 110 may present the first panel in response to detecting a trigger acting on a first part of the media content, for example, a long press operation or a selection operation acts on the first part of the media content. At this time, a plurality of search items matching a first object identified from the first part are presented in the first panel. Referring to FIGS. 2A and 2B, in the example interface 200A, the media content includes a man dressed in a shirt, long pants and casual shoes. If the terminal device 110 receives the trigger on the media content at the part of the shirt in the media content, it may be determined that the trigger acts on this part, and then the example interface 200B is presented, and a plurality of search items matching the shirt identified from this part are presented in the first panel.

In some embodiments, if the media content further includes text, the terminal device 110 may, in response to receiving a trigger on a text part, determine a part matching the text part from visual data of the media content, and determine this part as a part on which the trigger acts. For example, if the media content includes an image and a description text of the image, the image includes a man dressed in a shirt, and the description text includes at least the text "shirt", the terminal device 110 may, in response to receiving a trigger on the text "shirt", determine a part matching the text (that is, the part where the shirt is located in the image) from the visual data of the media content, and determine the part as a part targeted by the trigger initiated by the user.

In some embodiments, if no object is identified from the first part, the terminal device 110 may also present, in the first panel, a plurality of search items matching at least one second object, where the at least one second object is identified from a part other than the first part of the media content. For example, still referring to FIGS. 2A and 2B, if the trigger acts on the part where the shirt is located in the example interface 200A, and the terminal device 110 fails to identify the shirt successfully, the terminal device 110 may present, in the first panel 210, a plurality of search items matching an object identified in the other parts of the media content, for example, an object matching the long pants identified from the part where the long pants are located. It should be noted that the other parts may be any other parts in an image or a video frame presented by the first interface when the media content is triggered, and may also be other images included in the media content, or other video frames in the video.

In some embodiments, if the plurality of search items in the first panel match a certain object in the media content, the terminal device 110 may further, in response to determining a plurality of search items matching at least one object other than the object in the media content, present at least one object identification mark in the first interface in association with these objects respectively. The object identification mark may be any appropriate mark, for example, a circle or a dot. Each object identification mark indicates that the object has a corresponding search result, so that the user may determine whether to view further according to actual needs. For example, if the media content includes a man dressed in a shirt and long pants, and the plurality of search items in the first panel match the shirt, the terminal device 110 may, in response to determining a plurality of search items (which are not presented in the first panel) matching the long pants, present an object identification mark associated with the long pants in the media content of the first interface. Therefore, by presenting the object identification mark, the user may be informed that the object corresponding to the object identification mark also has a plurality of search items.

In some embodiments, the first panel is superimposed on a first area of the first interface, and the terminal device 110 may further present at least a part of the media content in a second area of the first interface. To be convenient for the user to know which part of the media content the object corresponding to the plurality of search items in the first panel is located in, for example, the terminal device 110 may control presentation of at least a corresponding part of the media content in the second area of the first interface while presenting the first panel. It should be understood that the terminal device 110 may move the position of the media content to cause the part corresponding to the plurality of search items in the first panel (that is, the part where the object matching the plurality of search items is located) to be presented in the second area. For example, if the trigger on the media content acts on a part A of the media content, and the terminal device 110 may identify an object from the part A, the terminal device 110 may superimpose the first panel on the first area of the first interface and present a plurality of search items corresponding to the object in the first panel. Correspondingly, the terminal device 110 may also move the media content to cause the part A to be at least partially presented in the second area.

In some embodiments, the terminal device 110 may further superimpose a selection box on the part corresponding to the plurality of search items in the first panel in the media content to indicate the selected state of that part, that is, to indicate that the search items currently presented in the first panel match the object in that part. The terminal device 110 may further receive an adjustment operation on the selection box. The adjustment operation may include a movement operation, an enlargement operation, a narrowing operation, etc., directly for the selection box.

In some embodiments, the terminal device 110 may further, in response to receiving a trigger on a part different from the part corresponding to the plurality of search items in the first panel, determine that a movement operation of moving the selection box from the part corresponding to the plurality of search items in the first panel to the part is received. It should be understood that the part covered by the selection box after the enlargement operation/narrowing operation is different from the part covered by the selection box without adjustment previously.

For example, the terminal device 110 may, in response to the selection box being adjusted to a second part of the media content, replace the plurality of search items currently presented in the first panel with a plurality of search items matching an object identified from the second part. Referring to FIG. 2D, the content of the media content may be a man dressed in a shirt and long pants. In the example interface 200D, the selection box 201 is superimposed on the part where the shirt is located in the media content, and the plurality of search items presented in the first panel 210 match the object (that is, the shirt) identified from the part where the shirt is located. The terminal device 110 may present the example interface 200E of FIG. 2E in response to the selection box 201 being adjusted to the part where the long pants are located in the media content. In the example interface 200E, the selection box 201 is superimposed on the part where the long pants are located, and the plurality of search items presented by the first panel 210 match the object (e.g., the long pants) identified from the part where the long pants are located.

In some embodiments, the terminal device 110 may further expand the first panel to present a plurality of search items in response to a predetermined operation on the first panel. It should be understood that the number of the plurality of search items presented by the expanded first panel exceeds the number of the plurality of search items presented by the unexpanded first panel. The expanded first panel includes: at least one part in the media content when the media content is triggered, with each part including at least one object, and a plurality of search items matching the at least one object included in the part currently selected. The terminal device 110 may maintain the presentation of the at least one interactive control in the expanded first panel, or may cancel the presentation of the at least one interactive control in the expanded first panel.

The predetermined operation on the first panel may include an expansion indication for the first panel. For example, the terminal device 110 may determine that the expansion indication for the first panel is received in response to receiving a pull-up operation, a double-click operation, a trigger on an expansion control in the first panel, etc. As an example, referring to FIGS. 2D and 2F, the first panel 210 of the example interface 200D includes an expansion control 211, and the terminal device 110 may determine that the expansion indication for the first panel 210 is received in response to receiving a trigger operation (for example, a click, an up-sliding operation, etc.) on the expansion control 211, and then expand the presentation size of the first panel in the first interface. The terminal device 110 may present the example interface 200F. The example interface 200F includes at least one part (for example, a part 232, a part 233, and a part 234) in the media content when the media content is triggered, and each part includes at least one object.

The first panel 210 of the example interface 200F may include a plurality of search items matching the at least one object included in the part currently selected, and the part currently selected may be, by default, the part indicated by the selection box 201 in the example interface 200D. For example, the terminal device 110 may highlight the part currently selected. For example, the terminal device 110 may switch the plurality of search items presented in the first panel 210 in response to receiving a selection of a part different from the part currently selected in the example interface 200F, so that the plurality of search items corresponding to the other part selected are presented in the first panel 210.

The first panel 210 in the example interface 200F may further include at least one classification label. A plurality of search items corresponding to different classification labels are different. For example, the at least one classification label may include a label "by similarity" and a label "product" as shown in the figure. In some embodiments, the terminal device 110 may sort the plurality of search items according to the similarities between the plurality of search items and the object in the media content, and present the plurality of search items based on the sorting result, in response to the label "by similarity" being currently selected. In some embodiments, the label "by similarity" may be selected by default. In some embodiments, the terminal device 110 may present a product associated with the object in the media content in the first panel 210 in response to the label "product" being currently selected. Certainly, it should be understood that in addition to these two types of labels, the search results may also be classified according to other classification standards and granularity, and the corresponding classification labels may be presented in the first panel, so that it is convenient for the user to classify and view according to actual needs.

In some embodiments, the first panel may further include a search viewing control. In this case, the predetermined operation on the first panel may include a trigger on the search viewing control in the first panel. As an example, referring to FIGS. 2G and 2F, the first panel 210 of the example interface 200G includes a search viewing control 216. The search viewing control 216 indicates a search for a matching object of the media content. The terminal device 110 may determine that the expansion indication for the first panel 210 is received in response to receiving a trigger operation on the search viewing control 216, and then expand the first panel to provide more search results. The terminal device 110 may present the example interface 200F, in which the expanded first panel is presented.

In some embodiments, in the case that the first panel includes the search viewing control, the terminal device 110 may expand the first panel in response to receiving the expansion indication for the first panel. The expanded first panel includes at least one interactive control, the search viewing control, and a plurality of search items. In this case, the plurality of search items presented in the expanded first panel correspond to the same object or part as the plurality of search items presented in the unexpanded first panel. As an example, referring to FIGS. 2G and 2H, the terminal device 110 may determine that the expansion indication for the first panel 210 is received in response to receiving the up-sliding operation on the expansion control 211, and then expand the first panel as shown in the example interface 200H.

In some embodiments, after the first panel is expanded, the terminal device 110 may further narrow the first panel in response to receiving a narrowing indication for the first panel. For example, the terminal device 110 may determine that the narrowing indication for the first panel is received in response to receiving a down-sliding operation on the first panel, a down-sliding operation on the expansion control in the first panel, etc. Referring to FIGS. 2F, 2G, 2H and 2I, the terminal device 110 may switch from the example interface 200F back to the example interface 200I in response to the narrowing indication for the first panel 210 in the example interface 200F. The terminal device 110 may switch from the example interface 200H back to the example interface 200G in response to the narrowing indication for the first panel 210 in the example interface 200H.

In some embodiments, if the media content includes a video, the terminal device 110 may pause the playing of the video or may continue playing the video when presenting the first panel. That is, the terminal device 110 may pause the playing of the video or maintain the playing of the video in response to the presentation of the first panel. If the playing of the video is paused, the terminal device 110 may resume the playing of the video in the first interface in response to cancelling the presentation of the first panel. For example, if the terminal device 110 receives the trigger on the video at the 10th second of the video and presents the first panel, the terminal device 110 may resume the playing of the video in the first interface (that is, continue playing the video from the 10th second) in response to cancelling the presentation of the first panel. If the playing of the video is maintained, the terminal device 110 may continue playing the video in the first interface according to the playback progress of the video, in response to cancelling the presentation of the first panel. For example, if the terminal device 110 receives the trigger on the video at the 10th second of the video and presents the first panel, supposing that the first panel is presented for 10 seconds (during which the video continues to play), the terminal device 110 may continue playing the video in the first interface according to the playback progress of the video (for example, continue playing the video from the 20th second) in response to cancelling the presentation of the first panel.

In some embodiments, the terminal device 110 may further switch from the first interface to a presentation interface corresponding to a certain search item (for example, which may be referred to as a second interface) in response to a trigger on the search item among the plurality of search items in the first panel. The presentation interface presents the detailed information of the triggered search item. For example, if the triggered search item is media content, the terminal device 110 may switch to the presentation interface presenting the media content. If the triggered search item is a product, the terminal device 110 may switch to the presentation interface presenting the product, and such a presentation interface may also be referred to as a product detail interface.

In summary, according to various embodiments of the present disclosure, in the case that the media content is triggered, in addition to providing the interactive control, a plurality of search items matching the object in the media content are further provided in the presented panel. The user may obtain various search results corresponding to the object in the media content conveniently and quickly by simply triggering the presented panel, without requiring the user to perform complex interactions, which may improve the efficiency of the user to obtain information.

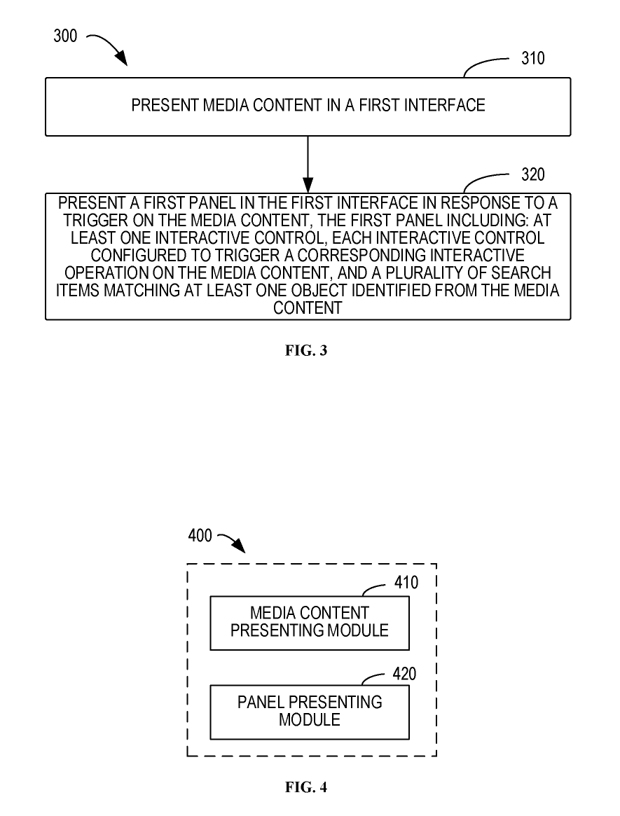

FIG. 3 illustrates a flowchart of a method 300 for search according to some embodiments of the present disclosure. The method 300 may be implemented at the terminal device 110.

At a block 310, the terminal device 110 presents media content in a first interface.

At a block 320, the terminal device 110 presents a first panel in the first interface in response to a trigger on the media content, the first panel includes: at least one interactive control, each interactive control is configured to trigger a corresponding interactive operation on the media content, and a plurality of search items matching at least one object identified from the media content.

In some embodiments, the presenting the first panel includes: presenting, in the first panel, a plurality of search items matching a first object identified from a first part of the media content, in response to the trigger acting on the first part of the media content.

In some embodiments, the presenting the first panel further includes: presenting, in the first panel, a plurality of search items matching at least one second object, in response to no object being identified from the first part, where the at least one second object is identified from a part other than the first part of the media content.

In some embodiments, the method 300 further includes: superimposing a selection box on the first part of the media content to indicate a selected state of the first part; and replacing, in the first panel, the plurality of search items matching the first object with a plurality of search items matching a third object identified from a second part of the media content, in response to the selection box being adjusted to the second part of the media content.

In some embodiments, the method 300 further includes: expanding the first panel to present the plurality of search items, in response to a predetermined operation on the first panel, and where the expanded first panel includes at least: at least one part in the media content when the media content is triggered, each part includes at least one object, and a plurality of search items matching at least one object included in a currently selected part.

In some embodiments, the presentation of at least one interactive control is canceled in the expanded first panel.

In some embodiments, the predetermined operation on the first panel includes: an expansion indication for the first panel, or a trigger on a search viewing control in the first panel.

In some embodiments, the first panel is superimposed on a first area of the first interface, and the method 300 further includes: presenting at least a part of the media content in a second area of the first interface.

In some embodiments, the method 300 further includes: in response to a fourth object among the at least one object appearing in a third part of the media content, controlling presentation of at least the third part of the media content in the second area of the first interface while presenting the first panel.

In some embodiments, the media content includes a video, and the method 300 further includes: pausing playing of the video in response to the presentation of the first panel; and resuming the playing of the video in the first interface in response to cancelling the presentation of the first panel.

In some embodiments, the media content includes a video, and the method 300 further includes: maintaining playing of the video in response to the presentation of the first panel; and continuing playing the video in the first interface according to a playback progress of the video, in response to cancelling the presentation of the first panel.

In some embodiments, the at least one interactive control includes a sharing control, and the method 300 further includes: presenting a second panel in response to a trigger on the sharing control, the second panel includes at least one sharing target associated with the media content.

In some embodiments, the plurality of search items in the first panel match a first object in the media content, and the method 300 further includes: in response to determining a plurality of search items matching at least one fifth object in the media content, presenting at least one object identification mark in the first interface in association with the at least one fifth object respectively, the at least one object identification mark indicate that the at least one fifth object has a corresponding search result.

In some embodiments, the method 300 further includes: switching from the first interface to a second interface corresponding to a first search item among the plurality of search items in response to a trigger on the first search item, the second interface presents the detailed information of the first search item.

In some embodiments, the plurality of search items matching each object are determined based on: determining attribute information of the object; determining a type of a search item matching the object based on the attribute information of the object; and obtaining, based on the determined type, a plurality of search items matching the object under the type.

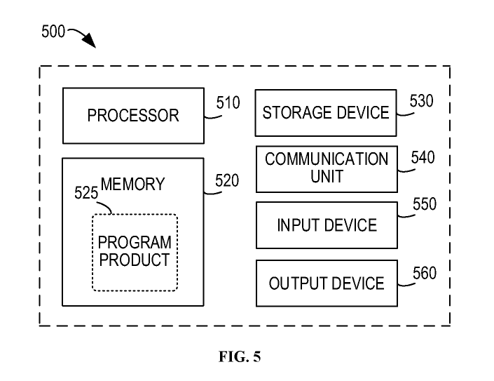

The embodiments of the present disclosure further provides a corresponding apparatus for implementing the above method or process. FIG. 4 illustrates an example structural block diagram of an apparatus 400 for search according to some embodiments of the present disclosure. The apparatus 400 may be implemented as or included in the terminal device 110. Each module/component in the apparatus 400 may be implemented by hardware, software, firmware, or any combination thereof.

As shown in FIG. 4, the apparatus 400 includes a media content presenting module 410 configured to present media content in a first interface. The apparatus 400 further includes a panel presenting module 420 configured to present a first panel in the first interface in response to a trigger on the media content, the first panel includes: at least one interactive control, each interactive control is configured to trigger a corresponding interactive operation on the media content, and a plurality of search items matching at least one object identified from the media content.

In some embodiments, the panel presenting module 420 is further configured to: present, in the first panel, a plurality of search items matching a first object identified from a first part of the media content, in response to the trigger acting on the first part of the media content.

In some embodiments, the panel presenting module 420 is further configured to: present, in the first panel, a plurality of search items matching at least one second object, in response to no object being identified from the first part, where the at least one second object is identified from a part other than the first part of the media content.

In some embodiments, the apparatus 400 further includes: a selection box presenting module configured to superimpose a selection box on the first part of the media content to indicate a selected state of the first part; and a search item replacing module configured to replace, in the first panel, the plurality of search items matching the first object with a plurality of search items matching a third object identified from a second part of the media content, in response to the selection box being adjusted to the second part of the media content.

In some embodiments, the apparatus 400 further includes: a panel expanding module configured to expand the first panel to present the plurality of search items, in response to a predetermined operation on the first panel, and where the expanded first panel includes at least: at least one part in the media content when the media content is triggered, each part includes at least one object, and a plurality of search items matching at least one object included in a currently selected part.

In some embodiments, the presentation of at least one interactive control is canceled in the expanded first panel.

In some embodiments, the predetermined operation on the first panel includes: an expansion indication for the first panel, or a trigger on a search viewing control in the first panel.

In some embodiments, the first panel is superimposed on a first area of the first interface, and the apparatus 400 further includes: a content presenting module configured to present at least a part of the media content in a second area of the first interface.

In some embodiments, the apparatus 400 further includes: a part presenting module configured to: in response to a fourth object among the at least one object appearing in a third part of the media content, control presentation of at least the third part of the media content in the second area of the first interface while presenting the first panel.

In some embodiments, the media content includes a video, and the apparatus 400 further includes: a playing pausing module configured to pause playing of the video in response to the presentation of the first panel; and a playing resuming module configured to resume the playing of the video in the first interface in response to cancelling the presentation of the first panel.

In some embodiments, the media content includes a video, and the apparatus 400 further includes: a playing maintaining module configured to maintain playing of the video in response to the presentation of the first panel; and a playing continuing module configured to continue playing the video in the first interface according to a playback progress of the video, in response to cancelling the presentation of the first panel.

In some embodiments, the at least one interactive control includes a sharing control, and the apparatus 400 further includes: a sharing panel presenting module configured to present a second panel in response to a trigger on the sharing control, the second panel includes at least one sharing target associated with the media content.

In some embodiments, the plurality of search items in the first panel match a first object in the media content, and the apparatus 400 further includes: a mark presenting module configured to: in response to determining a plurality of search items matching at least one fifth object in the media content, present at least one object identification mark in the first interface in association with the at least one fifth object respectively, the at least one object identification mark indicate that the at least one fifth object has a corresponding search result.

In some embodiments, the apparatus 400 further includes: an interface switching module configured to switch from the first interface to a second interface corresponding to a first search item among the plurality of search items in response to a trigger on the first search item, the second interface presents the detailed information of the first search item.

In some embodiments, the plurality of search items matching each object are determined based on: determining attribute information of the object; determining a type of a search item matching the object based on the attribute information of the object; and obtaining, based on the determined type, a plurality of search items matching the object under the type.

The modules included in the apparatus 400 may be implemented in various ways, including software, hardware, firmware, or any combination thereof. In some embodiments, one or more modules may be implemented using software and/or firmware, for example machine executable instructions stored on a storage medium. In addition to machine executable instructions or as an alternative, some or all modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and the like.

It should be understood that one or more steps in the above method may be performed by an appropriate electronic device or a combination of electronic devices. Such an electronic device or a combination of electronic devices may include, for example, the terminal device 110 in FIG. 1.

FIG. 5 illustrates a block diagram of an electronic device 500 in which one or more embodiments of the present disclosure may be implemented. It should be understood that the electronic device 500 shown in FIG. 5 is only example, and should not constitute any limitation on the functionality and scope of the embodiments described herein. The electronic device 500 shown in FIG. 5 may be used to implement the terminal device 110 in FIG. 1 or the apparatus 400 in FIG. 4.

As shown in FIG. 5, the electronic device 500 is in the form of a general electronic device. The components of the electronic device 500 may include, but are not limited to, one or more processing units or processors 510, a memory 520, a storage device 530, one or more communication units 540, one or more input devices 550, and one or more output devices 560. The processor 510 may be a physical or virtual processor, and may execute various processes based on the programs stored in the memory 520. In a multi-processor system, a plurality of processors execute computer executable instructions in parallel to improve the parallel processing capability of the electronic device 500.

The electronic device 500 typically includes a plurality of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or actions of the various embodiments of the present disclosure.

The communication unit 540 implements communication with other electronic devices through the communication medium. Additionally, the functions of the components of the electronic device 500 may be implemented by a single computing cluster or a plurality of computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any devices (such as a network card, a modem, etc.) that enable the electronic device 500 to communicate with one or more other electronic devices. Such communication may be performed via input/output (I/O) interfaces (not shown).

According to an example implementation of the present disclosure, a computer-readable storage medium is provided, on which computer-executable instructions are stored, where the computer-executable instructions are executed by a processor to implement the method described above. According to an example implementation of the present disclosure, there is further provided a computer program product tangibly stored on a non-transitory computer-readable medium and including computer-executable instructions, and the computer-executable instructions are executed by a processor to implement the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that when these instructions are executed by the processor of the computer or other programmable data processing apparatus, an apparatus for implementing the functions/actions specified in one or more blocks of the flowcharts and/or block diagrams is created. These computer-readable program instructions may also be stored in a computer-readable storage medium, these instructions cause a computer, a programmable data processing apparatus and/or other devices to work in a specific way, and thus, the computer-readable medium storing the instructions includes a manufacture, which includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus or other devices to produce a computer-implemented process, so that the instructions executed on the computer, other programmable data processing apparatus, or other devices implement the functions/actions specified in one or more blocks of the flowcharts and/or block diagrams.

The flowcharts and block diagrams in the drawings show the possibly implemented architectures, functions, and operations of the systems, methods and computer program products implemented according to the present disclosure. In this regard, each block in the flowchart or block diagram may represent a module, a program segment, or a part of instructions, and the module, the program segment, or the part of instructions contains one or more executable instructions for implementing the specified logical functions. In some implementations as updates, the functions marked in the blocks may also occur in an order different from that marked in the drawings. For example, two consecutive blocks may actually be executed substantially in parallel, or they may sometimes be executed in the reverse order, depending on the functions involved. It should also be noted that each block in the block diagrams and/or flowcharts, and the combination of the blocks in the block diagrams and/or flowcharts, may be implemented by a special-purpose hardware-based system that performs specified functions or actions, or may be implemented by a combination of special-purpose hardware and computer instructions.

The implementations of the present disclosure have been described above, and the above description is example, non-exhaustive, and not limited to the disclosed implementations. Without departing from the scope and spirit of the illustrated implementations, many modifications and changes will be apparent to those of ordinary skill in the art. The choice of terms used herein is intended to best explain the principles of the implementations, the practical applications, or improvements to the technologies in the market, or to enable other ordinary skilled persons in the art to understand the implementations disclosed herein.

1. A method for search, comprising:
presenting media content in a first interface; and
presenting a first panel in the first interface in response to a trigger on the media content, the first panel comprising:
at least one interactive control, each interactive control configured to trigger a corresponding interactive operation on the media content, and
a plurality of search items matching at least one object identified from the media content.

2. The method of claim 1, wherein presenting the first panel comprises:
presenting, in the first panel, a plurality of search items matching a first object identified from a first part of the media content, in response to the trigger acting on the first part of the media content.

3. The method of claim 2, wherein presenting the first panel further comprises:
presenting, in the first panel, a plurality of search items matching at least one second object, in response to no object being identified from the first part, wherein the at least one second object is identified from a part other than the first part of the media content.

4. The method of claim 2, further comprising:
superimposing a selection box on the first part of the media content to indicate a selected state of the first part; and
replacing, in the first panel, the plurality of search items matching the first object with a plurality of search items matching a third object identified from a second part of the media content, in response to the selection box being adjusted to the second part of the media content.

5. The method of claim 1, further comprising:
expanding the first panel to present the plurality of search items, in response to a predetermined operation on the first panel, and wherein the expanded first panel comprises at least:
at least one part in the media content when the media content is triggered, each part comprising at least one object, and
a plurality of search items matching at least one object comprised in a currently selected part.

6. The method of claim 5, wherein the presentation of the at least one interactive control is canceled in the expanded first panel.

7. The method of claim 5, wherein the predetermined operation on the first panel comprises:
an expansion indication for the first panel, or
a trigger on a search viewing control in the first panel.

8. The method of claim 1, wherein the first panel is superimposed on a first area of the first interface, the method further comprising:
presenting at least a part of the media content in a second area of the first interface.

9. The method of claim 8, further comprising:
in response to a fourth object among the at least one object appearing in a third part of the media content, controlling presentation of at least the third part of the media content in the second area of the first interface while presenting the first panel.

10. The method of claim 1, wherein the media content comprises a video, the method further comprising:
pausing playing of the video in response to the presentation of the first panel; and
resuming the playing of the video in the first interface in response to cancelling the presentation of the first panel.

11. The method of claim 1, wherein the media content comprises a video, the method further comprising:
maintaining playing of the video in response to the presentation of the first panel; and
continuing playing the video in the first interface according to a playback progress of the video, in response to cancelling the presentation of the first panel.

12. The method of claim 1, wherein the at least one interactive control comprises a sharing control, the method further comprising:
presenting a second panel in response to a trigger on the sharing control, the second panel comprising at least one sharing target associated with the media content.

13. The method of claim 1, wherein the plurality of search items in the first panel match a first object in the media content, the method further comprising:
in response to determining a plurality of search items matching at least one fifth object in the media content, presenting at least one object identification mark in the first interface in association with the at least one fifth object respectively, the at least one object identification mark indicating that the at least one fifth object has a corresponding search result.

14. The method of claim 1, further comprising:
switching from the first interface to a second interface corresponding to a first search item among the plurality of search items in response to a trigger on the first search item, the second interface presenting detailed information of the first search item.

15. The method of claim 1, wherein the plurality of search items matching each object are determined based on:
determining attribute information of the object;
determining a type of a search item matching the object based on the attribute information of the object; and
obtaining, based on the determined type, a plurality of search items matching the object under the type.

16. An electronic device, comprising:
at least one processor; and
at least one memory coupled to the at least one processor and storing instructions executable by the at least one processor, the instructions, when executed by the at least one processor, causing the electronic device to perform operations comprising:
presenting media content in a first interface; and
presenting a first panel in the first interface in response to a trigger on the media content, the first panel comprising:
at least one interactive control, each interactive control configured to trigger a corresponding interactive operation on the media content, and
a plurality of search items matching at least one object identified from the media content.

17. The electronic device of claim 16, wherein presenting the first panel comprises:
presenting, in the first panel, a plurality of search items matching a first object identified from a first part of the media content, in response to the trigger acting on the first part of the media content.

18. The electronic device of claim 17, wherein presenting the first panel further comprises:
presenting, in the first panel, a plurality of search items matching at least one second object, in response to no object being identified from the first part, wherein the at least one second object is identified from a part other than the first part of the media content.

19. The electronic device of claim 17, wherein the operations further comprise:
superimposing a selection box on the first part of the media content to indicate a selected state of the first part; and
replacing, in the first panel, the plurality of search items matching the first object with a plurality of search items matching a third object identified from a second part of the media content, in response to the selection box being adjusted to the second part of the media content.

20. A non-transitory computer-readable storage medium having computer-executable instructions stored thereon, the computer-executable instructions being executable by a processor to implement operations comprising:
presenting media content in a first interface; and
presenting a first panel in the first interface in response to a trigger on the media content, the first panel comprising:
at least one interactive control, each interactive control configured to trigger a corresponding interactive operation on the media content, and
a plurality of search items matching at least one object identified from the media content.
